(19) United States
(12) Patent Application Publication
(10) Pub. No.: US 2026/0153607 A1
(43) Pub. Date: Jun. 4, 2026

(54) INFORMATION PROCESSING METHOD, INFORMATION PROCESSING DEVICE, AND RECORDING MEDIUM

(71) Applicant: Panasonic Intellectual Property Management Co., Ltd., Osaka (JP)

(72) Inventors: Risako TSUJIMURA, Kanagawa (JP); Yasunori ISHII, Osaka (JP)

(21) Appl. No.: 19/463,718

(22) Filed: Jan. 29, 2026

Related U.S. Application Data
(63) Continuation of application No. PCT/JP2024/021187, filed on Jun. 11, 2024.
(60) Provisional application No. 63/533,954, filed on Aug. 22, 2023.

(30) Foreign Application Priority Data
Jan. 25, 2024 (JP) 2024-009625

(51) Int. Cl. G01S 7/52

(52) U.S. Cl. CPC G01S 7/52036; G01S 7/52026

(57) ABSTRACT

An information processing method is an information processing method that is executed by a computer. The information processing method includes acquiring information based on reflected sound obtained by emitting ultrasound into a space and extracting, from the reflected sound, a reflected wave every cycle of emission of the ultrasound to extract reflected waves; generating time-series information by concatenating vectors based on the reflected waves each extracted every cycle of emission of the ultrasound; determining an action of a person in the space in accordance with an output of a trained model, the output being obtained by inputting the generated time-series information to the trained model, the trained model being configured to output, upon receipt of input of time-series information, a human action associated with the time-series information; and outputting a determination result.

### CROSS REFERENCE TO RELATED APPLICATIONS

This is a continuation application of PCT International Application No. PCT/JP2024/021187 filed on Jun. 11, 2024, designating the United States of America, which is based on and claims priority of U.S. Provisional Patent Application No. 63/533,954 filed on Aug. 22, 2023, and Japanese Patent Application No. 2024-009625 filed on Jan. 25, 2024. The entire disclosures of the above-identified applications, including the specifications, drawings and claims are incorporated herein by reference in their entirety.

### FIELD

The present disclosure relate to an information processing method, an information processing device, and a recording medium.

### BACKGROUND

Consideration is being given to realizing functions such as automatic control of home appliances or monitoring of the elderly based on users' actions by means of recognition of users' actions in living spaces. As technology for recognizing users' actions, for example, Patent Literature 1 discloses the use of a distance acquired from ultrasound that is emitted from an ultrasound emitter worn by a user and received by an ultrasound receiver.

### CITATION LIST

### Patent Literature

PTL 1: Japanese Unexamined Patent Application Publication No. 2012-130522

### SUMMARY

### Technical Problem

The technology disclosed in PTL 1, however, requires the user to wear a sensor such as an ultrasonic emitter, which imposes a physical burden on the user.

In view of this, the present disclosure provides an information processing method, an information processing device, and a recording medium that are capable of recognizing a user's action while reducing a physical burden imposed on the user.

### Solution to Problem

An information processing method according to one aspect of the present disclosure is an information processing method that is executed by a computer. The information processing method includes acquiring information based on reflected sound obtained by emitting ultrasound into a space, extracting, from the reflected sound, a reflected wave every cycle of emission of the ultrasound to extract reflected waves, generating time-series information by concatenating vectors based on the reflected waves each extracted every cycle of emission of the ultrasound, determining an action of a person in the space in accordance with an output of a trained model, the output being obtained by inputting the time-series information generated to the trained model, the trained model being configured to output, upon receipt of input of time-series information, a human action associated with the time-series information, and outputting a determination result.

An information processing device according to one aspect of the present disclosure includes an acquirer that acquires information based on reflected sound obtained by emitting ultrasound into a space, an extractor that extracts, from the reflected sound, a reflected wave every cycle of emission of the ultrasound to extract reflected waves, a generator that generates time-series information by concatenating vectors based on the reflected waves each extracted every cycle of emission of the ultrasound, a determiner that determines an action of a person in the space in accordance with an output of a trained model, the output being obtained by inputting the time-series information generated, the trained model being configured to output, upon receipt of input of time-series information, a human action associated with the time-series information, and an outputter that outputs a determination result.

A recording medium according to one aspect of the present disclosure is a non-transitory computer-readable recording medium having recorded thereon a program for causing a computer to execute the information processing method described above.

### Advantageous Effects

According to one aspect of the present disclosure, it is possible to realize an information processing method or the like capable of recognizing a user's action while reducing a physical burden imposed on the user.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram showing a functional configuration of an information processing device according to an embodiment.

FIG. 2 is a diagram for describing time-series information according to the embodiment.

FIG. 3 is a flowchart showing operations of an information processing system according to the embodiment.

FIG. 4 is a flowchart showing operations of an information processing system according to Variation 1 of the embodiment.

FIG. 5 is a flowchart showing operations of an information processing system according to Variation 2 of the embodiment.

FIG. 6 is a flowchart showing operations of an information processing system according to Variation 3 of the embodiment.

FIG. 7 is a flowchart showing a first example of operations of an information processing system according to Variation 4 of the embodiment.

FIG. 8 is a flowchart showing a second example of the operations of the information processing system according to Variation 4 of the embodiment.

FIG. 9 is a flowchart showing operations of an information processing system according to Variation 5 of the embodiment.

### DESCRIPTION OF EMBODIMENT

An information processing method according to a first aspect of the present disclosure is an information processing method that is executed by a computer. The information processing method includes acquiring information based on reflected sound obtained by emitting ultrasound into a space, extracting, from the reflected sound, a reflected wave every cycle of emission of the ultrasound to extract reflected waves, generating time-series information by concatenating vectors based on the reflected waves each extracted every cycle of emission of the ultrasound, determining an action of a person in the space in accordance with an output of a trained model, the output being obtained by inputting the time-series information generated to the trained model, the trained model being configured to output, upon receipt of input of time-series information, a human action associated with the time-series information, and outputting a determination result.

This information processing method uses the reflected sound of the ultrasound to determine a human action and thereby eliminates the need for a user to wear a sensor or the like. The method also uses the time-series information to determine a user's action. Accordingly, the information processing method is capable of recognizing the user's action while reducing a physical burden imposed on the user.

An information processing method according to a second aspect is the information processing method according to the first aspect, in which the time-series information may include information obtained by concatenating vectors of the reflected waves as the vectors based on the reflected waves.

Accordingly, the time-series information can be generated by using the vector of the reflected wave as-is.

An information processing method according to a third aspect is the information processing method according to the second aspect, in which the time-series information may include information obtained by arranging amplitudes of the reflected waves each extracted every cycle of emission of the ultrasound.

Accordingly, the time-series information can be generated by arranging an amplitude obtainable from the reflected wave extracted every cycle of emission of the ultrasound.

An information processing method according to a fourth aspect is the information processing method according to any one of the first to third aspects that may further include extracting, from the reflected sound, a direct wave every cycle of emission of the ultrasound to extract direct waves, and calculating impulse responses of the direct waves extracted and the reflected waves extracted. The time-series information may include information obtained by concatenating, as the vectors based on the reflected waves, vectors of the impulse responses each calculated every cycle of emission of the ultrasound.

This enables cancelling out the transfer characteristics of a transmitter (e.g., a loudspeaker) and a receiver (e.g., a microphone), thereby improving robustness of the information processing method in detection of the user's action.

An information processing method according to a fifth aspect is the information processing method according to the fourth aspect, in which the time-series information may include information obtained by arranging amplitudes of the impulse responses each calculated every cycle of emission of the ultrasound.

This enables generating the time-series information that is capable of improving robustness of the information processing method.

An information processing method according to a sixth aspect is the information processing method according to any one of the first to fifth aspects that may further include calculating envelopes of the reflected waves extracted. The time-series information may include information obtained by concatenating vectors of the envelopes as the vectors based on the reflected waves.

This enables eliminating phase information from the reflected sound, thereby reducing the influence of a change in phase caused by a slight change in the state of the space. Thus, it is expected to improve the accuracy of detecting the user's action.

An information processing method according to a seventh aspect is the information processing method according to any one of the first to sixth aspects that may further include extracting, from the reflected sound, a direct wave every cycle of emission of the ultrasound to extract direct waves, calculating impulse responses of the direct waves extracted and the reflected waves extracted, and calculating envelopes of the impulse responses. The time-series information may include information obtained by concatenating, as the vectors based on the reflected waves, vectors of envelopes of the impulse responses each calculated every cycle of emission of the ultrasound.

This enables reducing the influence of a change in phase caused by a slight change in the state of the space even in the case of using the impulse response. Thus, it is expected to improve the accuracy of detecting the user's action.

An information processing method according to an eighth aspect is the information processing method according to any one of the first to seventh aspects that may further include calculating acoustic features of the reflected waves each extracted every cycle of emission of the ultrasound. The time-series information may include information obtained by concatenating vectors of the acoustic features as the vectors based on the reflected waves.

This enables generating the time-series information by using the information based on the acoustic feature.

An information processing method according to a ninth aspect is the information processing method according to the eighth aspect, in which the acoustic features each may include a mel-frequency cepstrum coefficient.

This enables reducing the number of dimensions of the feature, thereby reducing calculation loads.

An information processing method according to a tenth aspect is the information processing method according to the eighth or ninth aspect, in which the acoustic features each may include a linear-frequency cepstrum coefficient.

This enables reducing the number of dimensions of the feature, thereby reducing calculation loads.

An information processing method according to an eleventh aspect is the information processing method according to any one of the first to tenth aspects that may further include substituting a portion of the reflected sound other than the reflected wave with a predetermined value. The time-series information may include information based on the reflected sound in which the portion has been substituted with the predetermined value.

With this method, the portion of the reflected sound other than the reflected wave is substituted with a predetermined value. This enables reducing the influence of this portion on the determination. Thus, it is expected to improve the accuracy of detecting the user's action.

An information processing device according to a twelfth aspect includes an acquirer that acquires information based on reflected sound obtained by emitting ultrasound into a space, an extractor that extracts, from the reflected sound, a reflected wave every cycle of emission of the ultrasound to extract reflected waves, a generator that generates time-series information by concatenating vectors based on the reflected waves each extracted every cycle of emission of the ultrasound, a determiner that determines an action of a person in the space in accordance with an output of a trained model, the output being obtained by inputting the time-series information generated, the trained model being configured to output, upon receipt of input of time-series information, a human action associated with the time-series information, and an outputter that outputs a determination result. A recording medium according to a thirteenth aspect is a non-transitory computer-readable recording medium having recorded thereon a program for causing a computer to execute the information processing method described above.

The information processing device and the recording medium described above achieve similar effects to those of the information processing method described above.

These general and specific aspects may be implemented using a system, a method, an integrated circuit, a computer program, or a non-transitory recording medium such as a computer-readable CD-ROM, or any combination of a system, a method, an integrated circuit, a computer program, or a recording medium. The program may be stored in advance in the recording medium, or may be supplied to the recording medium via a wide-area communication network such as the Internet.

Hereinafter, an exemplary embodiment is described in a greater detail with reference to the accompanying drawings.

The exemplary embodiment described below shows a generic or specific example. Numerical values, shapes, materials, constituent elements, arrangement positions and connection forms of the constituent elements, steps, the order of steps, and so on shown in the following exemplary embodiment are mere examples and therefore do not intend to limit the scope of the present disclosure. Among the constituent elements in the following embodiment, those not recited in any one of the independent claims are described as optional constituent elements.

Each of the accompanying drawings is a schematic diagram and does not always strictly follow the actual configuration. Therefore, for example, scale reduction or the like in each drawing is not necessarily the same. In each drawing, identical constituent elements are given the same reference numerals, and redundant descriptions thereof shall be omitted or simplified.

In the specification of the present disclosure, terms that indicate the relationship of elements such as being the same, terms that indicate the shapes of elements such as sine curves, numerical values, and the ranges of numerical values are not the expressions that represent only precise meaning, and are also the expressions that mean the inclusion of substantially equivalent ranges such as differences within the range of several percents (or about 10%).

### Embodiment

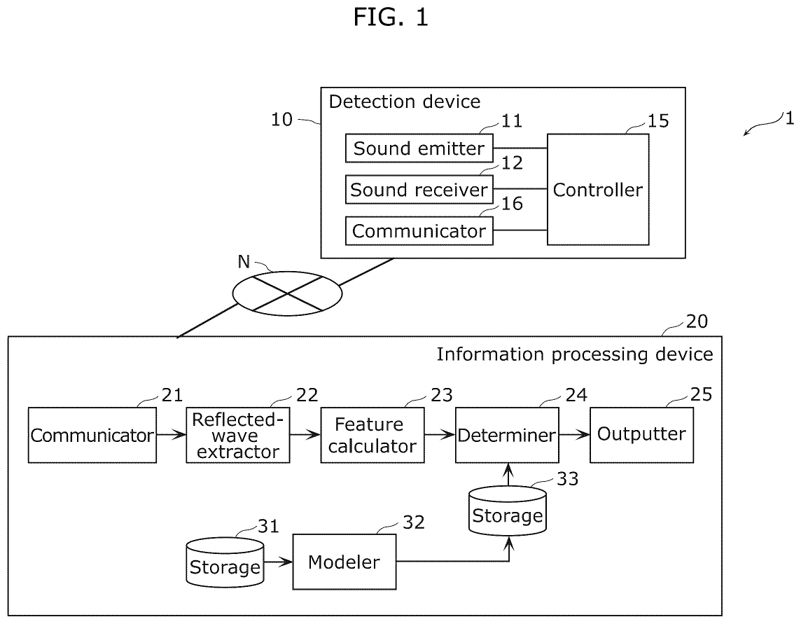

Hereinafter, an information processing system that includes an information processing device according to the present embodiment is described with reference to FIGS. 1 to 3.

### 1. Configuration of Information Processing System

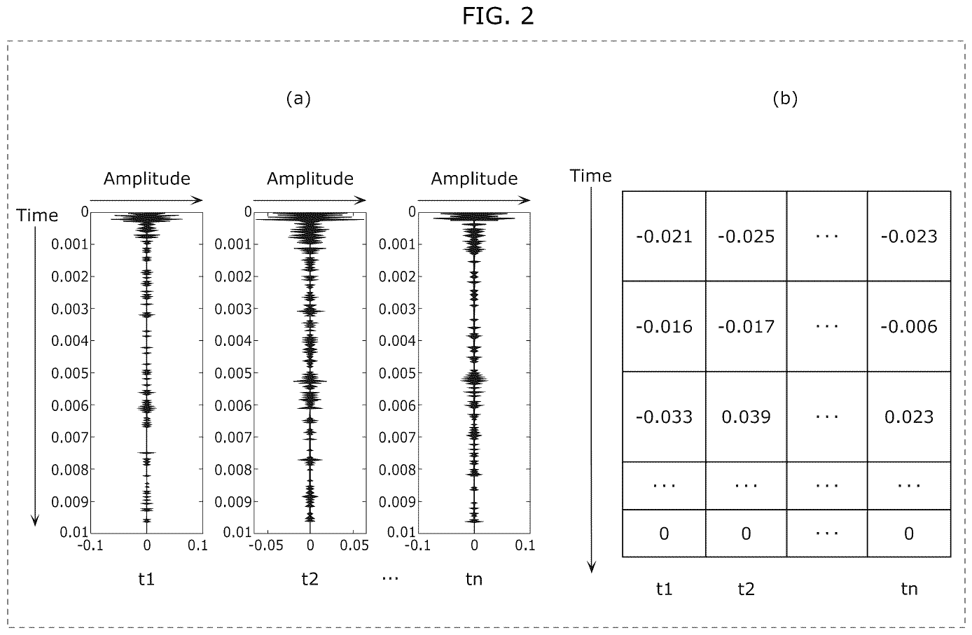

First, a configuration of an information processing system according to the present embodiment is described with reference to FIGS. 1 and 2. FIG. 1 is a block diagram showing a functional configuration of information processing system 1 according to the present embodiment.

Information processing system 1 is an action recognition system for recognizing a user's action in a space where the user is present (e.g., a living space) and, for example, is used to recognize a user's action in systems such as a system for controlling home electrical appliances or a system for monitoring the elderly. The present disclosure describes information processing device 20 capable of recognizing a user's action in a non-contact manner without requiring the user to wear a sensor. Specifically, the present disclosure describes information processing device 20 that recognizes a user's action by using reflected waves of ultrasound. Note that the space where the user is present may be an indoor space or an outdoor space.

As shown in FIG. 1, information processing system 1 includes detection device 10 and information processing device 20.

Detection device 10 is a device that emits and receives ultrasound for use in recognizing people's actions in a space. Detection device 10 is configured to be capable of emitting ultrasound into a space and receiving reflected sound reflected from people. Detection device 10 may be realizes as part of a system or the like that controls home electrical appliances. Detection device 10 may also be a stationary device or a portable device having portability. Detection device 10 is communicably connected to information processing device 20 via network N and transmits information acquired by detection device 10 to information processing device 20.

Detection device 10 includes sound emitter 11, sound receiver 12, controller 15, and communicator 16.

Sound emitter 11 is, for example, an ultrasound emitter that includes a loudspeaker or the like and emits ultrasound into a predetermined space. For example, sound emitter 11 may emit burst waves or chirp signals having frequencies outside the audible range (e.g., lower than 20 Hz, or higher than or equal to 20 kHz and lower than or equal to 100 kHz) at a specific cycle. Sound within the frequency band of the emitted sound (ultrasound) does not include an audio range. The cycle is, for example, 15 milliseconds (ms), but is not limited thereto. Sound emitter 11 is installed in a space where the user is present. That is, the user is not wearing sound emitter 11. Sound emitter 11 can also be referred to as a non-contact emitter. The sound emitted from sound emitter 11 is reflected on people and collected as reflected sound by sound receiver 12.

The burst waves are signals emitted at predetermined time intervals. The burst waves are such that a domain where a signal exists and a domain where no signals exist are repeated in a time domain. Using the burst waves brings about the advantage of being capable of separately grasping direct waves and reflected waves.

Sound receiver 12 is, for example, a receiver that includes a 1-or more channel (ch.) microphone and receives reflected sound including reflected waves of the ultrasound emitted from sound emitter 11. Sound receiver 12 also receives direct waves of the ultrasound emitted from sound emitter 11. That is, the reflected sound may include direct waves. The direct waves are signals obtained when the ultrasound emitted from sound emitter 11 has arrived directly at sound receiver 12, whereas the reflected waves are signals received at sound receiver 12 after the arrival of the direct waves. The reflected waves include signals obtained when the ultrasound emitted from sound emitter 11 is reflected on a target object such as a person. Sound receiver 12 is installed in a space where a user is present. That is, the user does not wear sound receiver 12. Sound receiver 12 can also be referred to as a non-contact receiver. Sound receiver 12 is one example of an acquirer.

Controller 15 is a processor that controls sound emitter 11, sound receiver 12, and communicator 16. Controller 15 transmits information about a sound-emitting signal and information about a sound-receiving signal to information processing device 20 via communicator 16, the sound-emitting signal being a signal for allowing sound emitter 11 to emit sound, the sound-receiving signal being based on the reflected sound acquired by sound receiver 12.

Communicator 16 is a communication module that is communicably connected to information processing device 20 via network N. For example, communicator 16 is wirelessly connected to network N.

Information processing device 20 is a device for recognizing people's actions in a space in accordance with signals received from detection device 10. Specifically, information processing device 20 is a device for recognizing people's actions in a space in accordance with information based on the sound-receiving signal obtained by sound receiver 12 such as a microphone receiving the reflected sound acquired when sound emitter 11 such as a loudspeaker has emitted ultrasound into a space.

Information processing device 20 includes, as its functional configuration, communicator 21, reflected-wave extractor 22, feature calculator 23, determiner 24, outputter 25, storages 31 and 33, and modeler 32. Information processing device 20 is realized by, for example, nonvolatile memory that stores programs, volatile memory serving as a temporary storage area for program execution, input/output ports, a communication interface, and a processor that executes programs. Information processing device 20 is realized as, for example, a server device. Note that information processing device 20 may be a desktop personal computer (PC), a mobile terminal such as a portable PC, a smartphone, or a tablet, or a dedicated computer. Information processing device 20 may also be realized as a server device (e.g., a cloud server).

Communicator 21 is a communication module and is communicably connected to detection device 10 via network N. Communicator 21 acquires information output from detection device 10 and outputs the acquired information to reflected-wave extractor 22.

Reflected-wave extractor 22 includes, for example, a band-pass filter or a band-reject filter and serves to eliminate unnecessary frequency components from signals received by sound receiver 12 and extract signals in a reflected-wave section (reflected-wave data). The extracted reflected-wave data may be stored in a storage (not shown). The unnecessary frequencies refer to frequencies other than the frequencies emitted by sound emitter 11 and include, for example, frequencies within the audible range. The reflected-wave section can be identified based on the time of arrival since the arrival of the direct waves. Reflected-wave extractor 22 is one example of an extractor.

In this way, in the present embodiment, reflected-wave extractor 22 acquires information about sound within the non-audible range. By acquiring the information about the sound within the non-audible range, information about the sound of people speaking is not collected. This protects the privacy of people in the space.

Feature calculator 23 concatenates the extracted reflected waves in time sequence. For example, feature calculator 23 concatenates the reflected waves acquired over a predetermined period of time (e.g., one second). The term “concatenation” as used herein refers to processing for associating a plurality of reflected waves received within a predetermined period of time as single input data to be input to a trained model. More specifically, the term “concatenation” refers to processing for creating a single matrix serving as input data, based on a plurality of reflected waves. Feature calculator 23 is one example of a generator.

FIG. 2 is a diagram for describing time-series information according to the present embodiment. In FIG. 2, (a) shows, for reference to facilitate understanding, waveform data of the reflected waves in which the reflected waves for respective cycles of emission of the ultrasound are arranged in a lateral direction. In FIG. 2, (b) shows a matrix of the amplitudes of the reflected waves, which is information to be input to a trained model. In (a) and (b) in FIG. 2, the vertical axis indicates time in the reflected-wave section, and the horizontal axis indicates the timing of receipt of the reflected waves. FIG. 2 shows an example in which n reflected waves are acquired in order at times t1, t2, . . . , and tn. Note that the waveform data may vary in amplitude and cycle according to people's actions.

As shown in (b) in FIG. 2, the time-series information includes amplitude values for respective items of the waveform data arranged in the lateral direction in order of the timing of receipt. The time-series information includes, for each waveform data item, amplitude values acquired at predetermined time intervals.

In FIG. 2, (a) shows graphs that visualize the matrix shown in (b) in FIG. 2 to facilitate understanding, the graphs being diagrams in which the reflected waves for respective cycles of emission of the ultrasound are arranged in the lateral direction in order of the timing of receipt, where the horizontal axis indicates amplitude and the vertical axis indicates time. The waveform data at each time may vary if the user is moving. That is, the values in the matrix shown in (b) in FIG. 2 may also vary if the user is moving. Note that the reflected waves for respective cycles of emission of the ultrasound may be arranged in, for example, a longitudinal direction.

In this way, the time-series information includes information based on time-series data of the amplitude values. It can also be said that the amplitude values are feature values. Note that the time-series information may be shown using a color distribution in which the amplitudes are converted into brightness, color saturation, or RGB values according to the amplitude values.

Referring again to FIG. 1, determiner 24 determines a user's action in accordance with the time-series information created by feature calculator 23. Determiner 24 uses a trained model created by modeler 32 to determine a user's action. The trained model is a machine learning model trained to, upon receipt of input of time-series information, output a human action associated with the time-series information.

Here, the user's action may, for example, be the action taken by the user himself/herself, or may be the movement of any part of the user's body. Examples of the user's action include standing, sitting, walking, running, lying down, waving a hand, jumping, throwing, and piking up. The user's action is, however, not limited thereto, and may include any other action that can be taken by a person. Determiner 24 may be configured to be capable of determining one or more actions.

Outputter 25 outputs a determination result obtained by determiner 24. For example, outputter 25 may transmit the determination result to a target system. Outputter 25 may be configured to, for example, include a communication interface.

Storage 31 stores learning data for use in modeler 32 to train a machine learning model. The learning data includes a plurality of sets of time-series information and people's actions at that time, the time-series information serving as input data. For example, storage 31 may be realized by semiconductor memory or the like, but is not limited thereto.

Modeler 32 creates a machine learning model trained using the learning data. More specifically, modeler 32 creates a machine learning model by supervised learning using the learning data. In the case of training a machine learning model, modeler 32 performs machine learning using the aforementioned time-series information as input data and people's actions (classes) as correct data. The created machine learning model (trained model) is a model that classifies people's actions into classes and, upon receipt of input of time-series information, outputs an inference result of inferring people's actions. Modeler 32 also stores the created trained model in storage 33.

Modeler 32 includes, for example, a computer including memory and a processor (microprocessor) and realizes various functions by the processor executing control programs stored in the memory.

Storage 33 stores the trained model created by modeler 32. Storage 33 may be realized by, for example, semiconductor memory or the like, but is not limited thereto.

Note that storage 31 and modeler 32 may be realized by a device different from information processing device 20. A learning device may be configured to include storage 31 and modeler 32 and communicably connected to information processing device 20.

### 2. Operations of Information Processing System

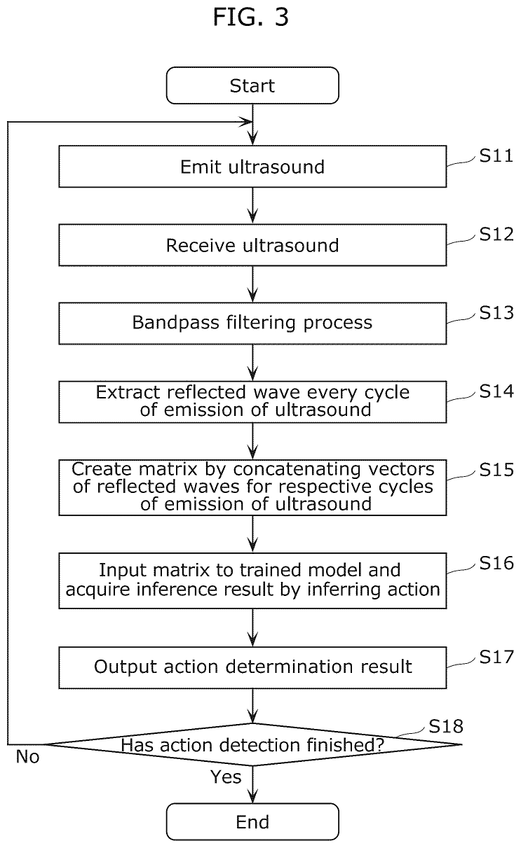

Next, operations of information processing system 1 configured as described above is described with reference to FIG. 3. FIG. 3 is a flowchart showing the operations of information processing system 1 (information processing method) according to the present embodiment. Steps S11 and S12 shown in FIG. 3 are operations to be executed by detection device 10, and steps S13 to S18 are operations to be executed by information processing device 20.

As shown in FIG. 3, first, sound emitter 11 emits ultrasound (S11), and sound receiver 12 receives ultrasound that includes reflected sound of the ultrasound emitted in step S11 (S12). For example, sound receiver 12 may receive a direct wave and a reflected wave. The reflected sound includes at least the reflected wave. Note that sound receiver 12 may receive a reflected wave corresponding to at least a target range for detecting people.

Controller 15 transmits information about the ultrasound emitted in step S11 and information about the ultrasound received in step S12 to information processing device 20 via communicator 16. Then, information processing device 20 acquires the information transmitted from detection device 10 via communicator 21. Note that the information about the received ultrasound includes information indicating the reflected wave (waveform data of the reflected wave). The information about the received ultrasound is one example of information based on the reflected sound. Communicator 21 also functions as an acquirer that acquires the information based on the reflected sound via communication.

Then, reflected-wave extractor 22 performs a band-pass filtering process on the received signal (including the reflected sound) received by sound receiver 12 (S13). Reflected-wave extractor 22 extracts signals having frequencies of the ultrasound emitted from sound emitter 11 from the received signal received by sound receiver 12.

Then, reflected-wave extractor 22 extracts a reflected wave every cycle of emission of the ultrasound from the received signal that has undergone the band-pass filtering process (S14). Reflected wave yᵢ is expressed by Expression 1 below, where y is the received signal received by sound receiver 12, yᵢ is the reflected-wave signal corresponding to the i-th emitted signal, N_{dir,i} is the starting index of the i-th emitted signal, Nₘᵢₙ (=2fₛdₘᵢₙ/c) is the index to a minimum distance to the detection target, and Nₘₐₓ (=2fₛdₘₐₓ/c) is the index to a maximum distance to the detection target.

yᵢ=y[N_{dir,i}+N_{min,i}, . . . , N_{dir,i}+Nₘₐₓ] Expression 1

Here, fₛ denotes the sampling frequency, dₘᵢₙ denotes the minimum distance to the detection target, dₘₐₓ denotes the maximum distance to the detection target, and c denotes the sound velocity.

Then, feature calculator 23 creates a matrix by concatenating reflected-wave vectors each obtained every cycle of emission of the ultrasound (S15). The reflected-wave vector is one example of a vector based on the reflected wave. When F_{ref} is given as a feature, feature F_{ref} is expressed by Expression 2 below.

F_{ref}=y[y₁,y₂, . . . , y_{N}] Expression 2

For example, the time-series information may include information obtained by horizontal concatenation of the reflected-wave vectors given by Expression 2. The term “horizontal concatenation” as used herein refers to forming a single matrix by arranging the reflected-wave vectors in the lateral direction. The time-series information obtained by the horizontal concatenation of the reflected-wave vectors may, for example, be the information shown in (b) in FIG. 2.

Then, determiner 24 inputs the matrix to the trained model and acquires an inference result of inferring people's actions (S16). As the inference result of inferring the user's action, determiner 24 acquires the output of the trained model, the output being obtained by inputting the matrix created in step S15 (e.g., the matrix shown in (b) in FIG. 2) to the trained model created by modeler 32. Determiner 24 further determines the user's action in accordance with the output of the trained model. Determiner 24 may use the inference result as the determination result.

Then, outputter 25 outputs the result of determining the user's action by determiner 24 (S17). Outputter 25 may transmit the determination result to a stationary device such as a display or a portable device such as a mobile terminal including a smartphone.

Then, information processing device 20 determines whether the action detection for detecting the user's action has finished (S18). If the action detection is determined to have finished (Yes in S18), information processing device 20 ends the processing, and if the action detection is determined to have not yet finished (No in S18), information processing device 20 returns to step S11 and continues the processing. If No in step S18, information processing device 20 transmits information that instructs detection device 10 to re-execute steps S11 and S12.

There are no particular limitations on the timing of execution of the processing shown in FIG. 3. The processing may be executed with predetermined timing, or may be executed at regular intervals.

### Variation 1 of Embodiment

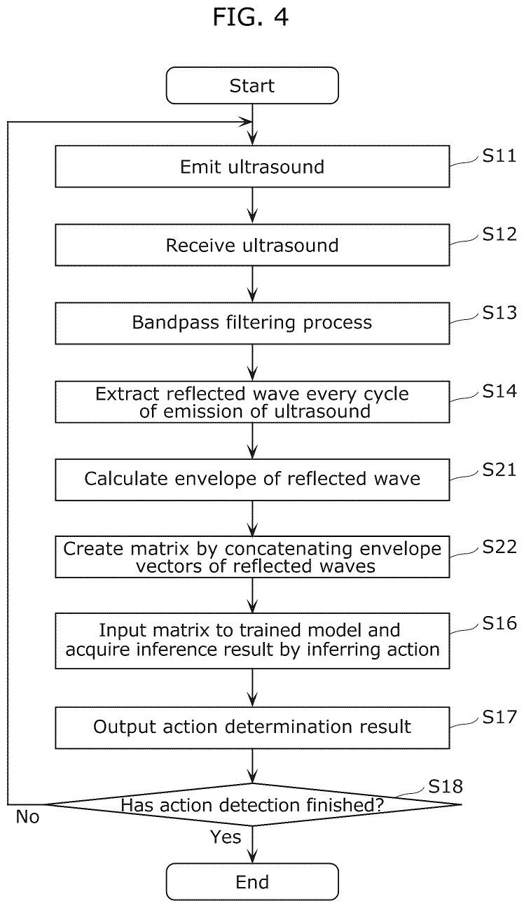

Hereinafter, an information processing system according to a variation of the present disclosure is described with reference to FIG. 4. Each variation described below focuses on differences from the embodiment, and descriptions of contents that are identical or similar to those described in the embodiment shall be omitted or simplified. A configuration of the information processing system according to each variation described below may be the same as that of information processing system 1 according to Embodiment 1, and each variation is described using reference signals used in information processing system 1 according to the embodiment.

FIG. 4 is a flowchart showing operations of information processing system 1 (information processing method) according to the present variation. The present variation describes an example in which the value of an envelope of the reflected wave for each cycle of emission of the ultrasound is used as the feature.

As shown in FIG. 4, after reflected-wave extractor 22 has extracted the reflected wave every cycle of emission of the ultrasound (S14), feature calculator 23 calculates an envelope of the reflected wave (S21). For each extracted reflected wave, feature calculator 23 calculates an envelope that connects each maximum value of the amplitude of the reflected wave. The number of envelopes to be calculated is equal to the number of the extracted reflected waves.

The use of the envelope allows only the amplitude of the reflected wave to be focused on. This excludes the influence of a shift in phase of the reflected wave caused by disturbances such as airflow. That is, the use of the envelope allows the exclusion of phase information, thereby reducing the influence of changes in phase caused by a slight change in the state of the space. Thus, it is expected to improve the accuracy of detection.

Then, feature calculator 23 creates a matrix by concatenating envelope vectors of the reflected waves (S22). Feature calculator 23 creates the matrix by arranging the amplitude values of the envelopes for respective extracted reflected waves in, for example, a lateral direction in order of the timing of receipt of the reflected waves. The created matrix is one example of the time-series information, and the envelope vector of each reflected wave is one example of the vector based on the reflected wave.

Reflected wave Fₑₙᵥ is expressed by Expression 3 below, where Fₑₙᵥ is the feature and yeᵢ is the envelope signal of the reflected wave corresponding to the i-th emitted signal.

Fₑₙᵥ=y[ye₁,ye₂, . . . ,+ye_{N}] Expression 3

In the present variation, modeler 32 performs machine learning by using the matrix created by concatenating the envelope vectors of the reflected waves as the time-series information (input data) and using the people's actions (classes) as correct data during the training of the machine learning model.

### Variation 2 of Embodiment

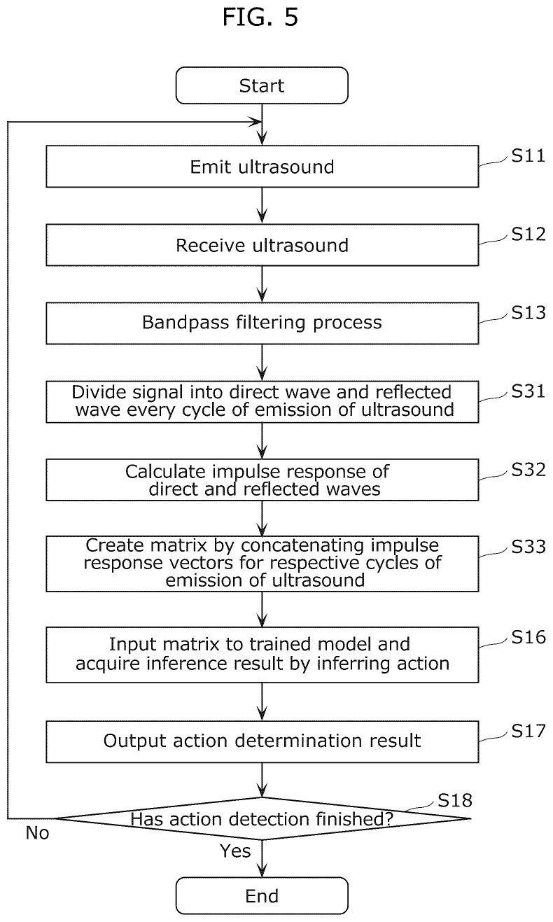

An information processing system according to another variation of the present disclosure is described hereinafter with reference to FIG. 5. FIG. 5 is a flowchart showing operations of information processing system 1 (information processing method) according to the present variation. The present variation describes an example in which the value of an impulse response of the direct wave and the reflected wave is used as the feature, instead of the reflected wave.

As shown in FIG. 5, reflected-wave extractor 22 divides a signal that has undergone the band-pass filtering process into a direct wave and a reflected wave every cycle of emission of the ultrasound (S31). Since the time to receive the direct wave can be acquired in advance, for example, reflected-wave extractor 22 uses this time to divide the signal that has undergone the band-pass filtering process into the direct wave and the reflected wave.

Then, feature calculator 23 calculates an impulse response of the direct wave and the reflected wave (S32). Specifically, feature calculator 23 converts the divided direct and reflected waves into frequency-domain signals by Fourier transform and performs division of the frequency-domain signal in the frequency domain so as to calculate a transfer function. When H_{rd,i} is given as a transfer function of the i-th direct and reflected waves, transfer function H_{rd,i} is expressed by Expression 4 below, where Y_{ref,i} is the frequency domain signal of the i-th direct wave, and Y_{dir,i} is the frequency domain signal of the i-th reflected wave. Here, ω denotes each angular frequency.

H_{rd,i}=Y_{ref,i}(ω)/Y_{dir,i}(ω) Expression 4

Then, feature calculator 23 converts transfer function H_{rd,i} back into the time-domain signal, i.e., the impulse response, by inverse Fourier transform and uses the impulse response as the feature. The signal waveform of the impulse response is expressed in a graph where the horizontal axis indicates time and the vertical axis indicates amplitude. When Fᵢᵣ is given as the feature, feature Fᵢᵣ is expressed by the following expression, where h_{rd,1} is the impulse response of the i-th direct and reflected waves.

Fᵢᵣ=[h_{rd,1},h_{rd,2}, . . . , h_{rd,N}] Expression 5

Feature calculator 23 creates a matrix by concatenating impulse-response vectors each obtained every cycle of emission of the ultrasound (S33). Feature calculator 23 creates the matrix by arranging the amplitude values for respective calculated impulse responses in, for example, a lateral direction in order of the timing of receipt of the reflected waves. The created matrix is one example of the time-series information, and each impulse response vector is one example of the vector based on the reflected wave.

By obtaining the impulse response of the direct and reflected waves captured by one sound emitter 11 (e.g., one loudspeaker) and one sound receiver 12 (e.g., one microphone), the transfer characteristics of sound emitter 11 and sound receiver 12 can be cancelled out. This enables determining people's actions even if sound emitter 11 and sound receiver 12 differ.

In the present variation, modeler 32 performs machine learning by using the matrix created by concatenating the impulse response vectors as the time-series information (input data) and using people's actions (classes) as correct data during training of the machine learning model.

### Variation 3 of Embodiment

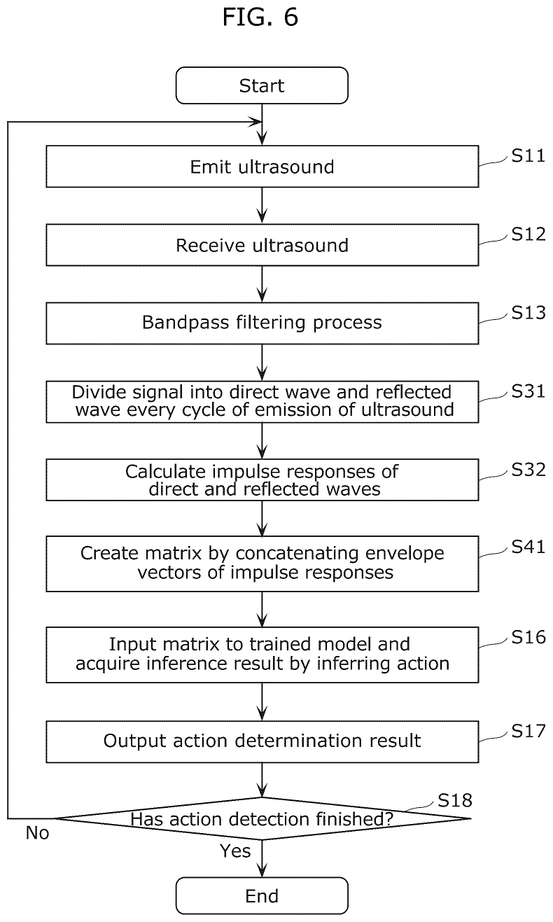

An information processing system according to yet another variation of the present disclosure is described hereinafter with reference to FIG. 6. FIG. 6 is a flowchart showing operations of information processing system 1 (information processing method) according to the present variation. The present variation describes an example in which the value of an envelope of the impulse response is used as the feature, instead of the reflected wave.

As shown in FIG. 6, feature calculator 23 calculates an impulse response of the direct wave and the reflected wave every cycle of emission of the ultrasound (S32) and creates a matrix by concatenating envelope vectors of the impulse responses (S41). In step S41, feature calculator 23 calculates an envelope for every calculated impulse response. The number of envelopes to be calculated is equal to the number of calculated impulse responses.

Then, feature calculator 23 incorporates the same number of envelopes as the number of impulse responses into a single matrix so as to create a matrix in which the envelope vectors are concatenated. Feature calculator 23 creates the matrix by arranging the envelope values for respective calculated impulse responses in, for example, the lateral direction in order of the timing of receipt of the reflected waves. The created matrix is one example of the time-series information, and the envelope vector of each impulse response is one example of the vector based on the reflected wave.

This allows the exclusion of phase information even in the case of using the impulse responses and accordingly reduces the influence of a change in phase caused by a slight change in the state of the space. Thus, it is expected to improve the accuracy of detection.

In the present variation, modeler 32 performs machine learning by using the matrix created by concatenating the envelope vectors of the impulse responses as the time-series information (input data) and using people's actions (classes) as correct data during training of the machine learning model.

### Variation 4 of Embodiment

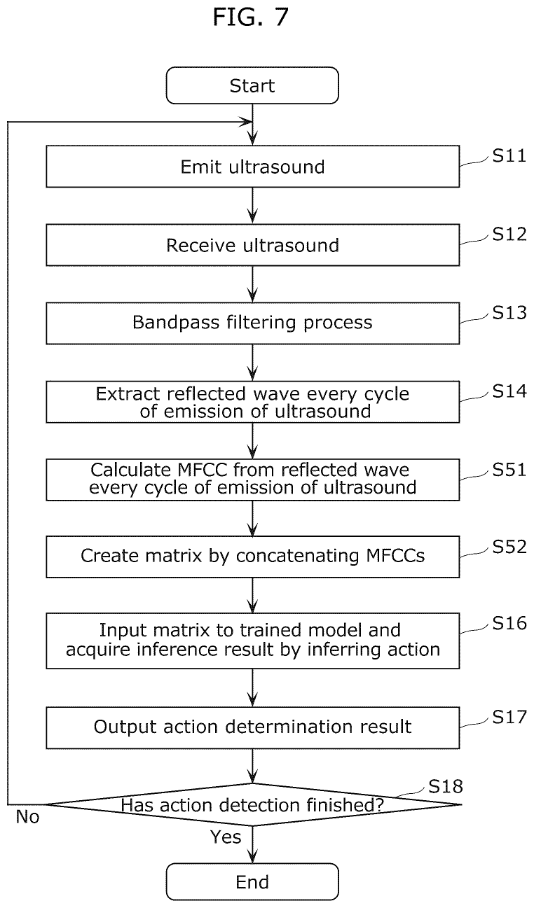

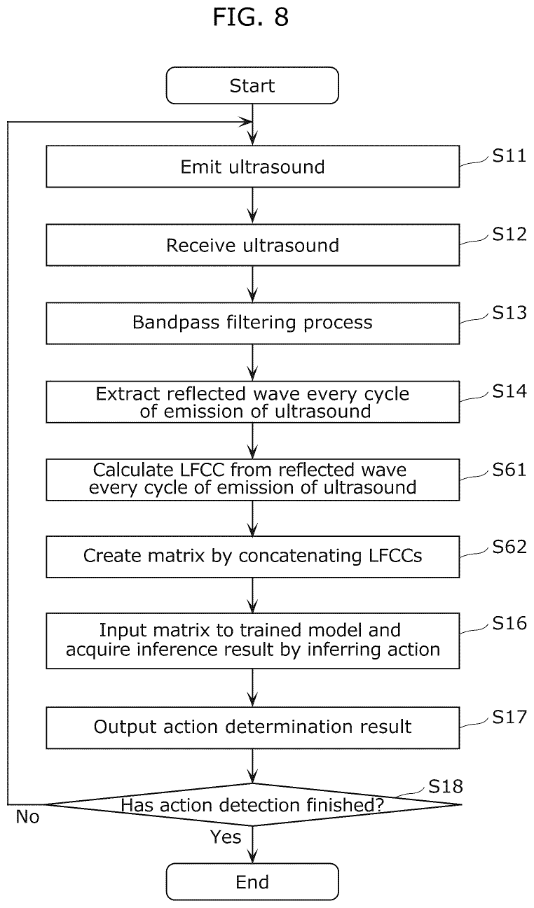

An information processing system according to yet another variation of the present disclosure is described hereinafter with reference to FIGS. 7 and 8. FIGS. 7 and 8 are flowcharts showing examples of operations of information processing system 1 (information processing method) according to the present variation. The present variation describes an example in which an acoustic feature is used as the feature. FIG. 7 shows an example of using a mel-frequency cepstrum coefficient (MFCC) as the acoustic feature, and FIG. 8 shows an example of using a linear-frequency cepstrum coefficient (LFCC) as the acoustic feature. Since the present disclosure uses signals within the ultrasonic range as signals to be emitted, MFCCs that do not reflect auditory characteristics may also be used as acoustic features, in addition to MFCCs that reflect auditory characteristics.

As shown in FIG. 7, after reflected-wave extractor 22 has extracted the reflected wave every cycle of emission of the ultrasound (S14), feature calculator 23 may calculate the MFCC from the reflected wave every cycle of emission of the ultrasound (S51). Note that a mel-filter bank targets only the frequency band of the emitted signal of the ultrasound.

Then, feature calculator 23 may create a matrix by concatenating the MFCCs (S52). Feature calculator 23 may create the matrix by arranging the values of the MFCCs for respective extracted reflected waves in, for example, the lateral direction in order of the timing of receipt of the reflected waves. The created matrix is one example of the time-series information, and each MFCC is one example of the vector based on the reflected wave.

When F_{MFCC} is given as the feature, feature F_{MFCC} is expressed by Expression 6 below, where and C_{m,i} is the MFCC of the reflected wave corresponding to the i-th emitted signal.

F_{MFCC}=[C_{m,1},C_{m,2}, . . . , C_{m,N}] Expression 6

As shown in FIG. 8, after reflected-wave extractor 22 has extracted the reflected wave every cycle of emission of the ultrasound (S14), feature calculator 23 may also calculate an LFCC from the reflected wave every cycle of emission of the ultrasound (S61). Note that a filter bank targets only the frequency band of the ultrasonic emitted signal.

Then, feature calculator 23 may create a matrix by concatenating the LFCCs (S62). Feature calculator 23 may create the matrix by arranging the values of the LFCCs for respective extracted reflected waves in, for example, the lateral direction in order of the timing of receipt of the reflected waves. The created matrix is one example of the time-series information, and each LFCC is an acoustic feature vector, which is one example of the vector based on the reflected wave.

When F_{LFCC} is given as the feature, feature F_{LFCC} is expressed by Expression 7 below, where and C_{l,i} is the LFCC of the reflected wave corresponding to the i-th emitted signal.

F_{LFCC}=[C_{l,1},C_{l,2}, . . . , C_{l,N}] Expression 7

From these, it is possible to reduce the number of dimensions of the feature, as compared with the case where the reflected waves are used as-is, and to reduce computational loads on information processing device 20.

In the present variation, modeler 32 performs machine learning by using the matrix created by concatenating the MFCCs or the LFCCs as the time-series information (input data) and using people's actions (classes) as correct data during training of the machine learning model.

### Variation 5 of Embodiment

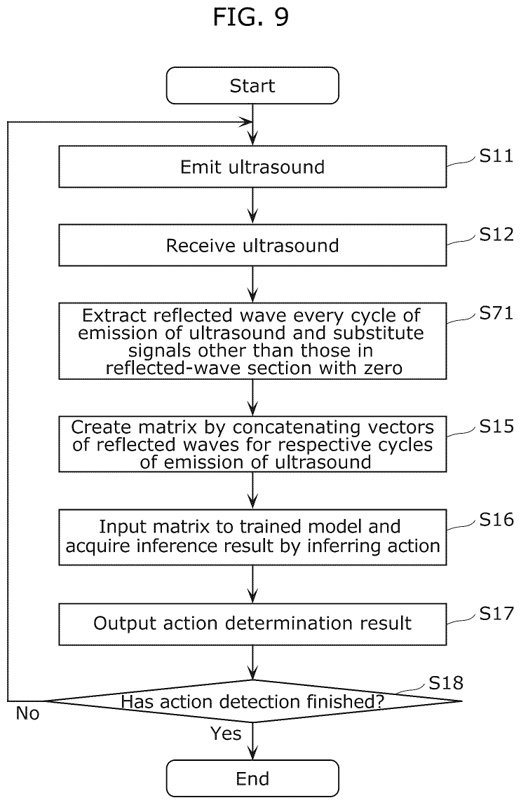

An information processing system according to yet another variation of the present disclosure is described hereinafter with reference to FIG. 9. FIG. 9 is a flowchart showing operations of information processing system 1 (information processing method) according to the present variation. The present variation describes an example in which envelope values of envelope vectors of impulse responses are used as features.

As shown in FIG. 9, reflected-wave extractor 22 extracts an reflected wave from the received ultrasound (received signal) every cycle of emission of the ultrasound and substitutes signals (the amplitudes of signals) other than those in the reflected-wave section with zero (S71). For example, the amplitude of a portion of the reflected wave that is mainly not affected by people's actions is substituted with zero. Accordingly, for example, the amplitude of the direct wave included in the received signal becomes zero.

Note that the substitution value (one example of a predetermined value) is not limited to zero, and may be any value that can be set in advance.

Then, feature calculator 23 creates a matrix by concatenating reflected-wave vectors each obtained every cycle of emission of the ultrasound (S15). The matrix created herein includes zero as signal components (the amplitudes of signals) other than those in the reflected-wave section. This matrix is one example of the time-series information (feature).

Note that the band-pass filtering process (e.g., S13 shown in FIG. 3 and so on) may be executed between steps S12 and S71.

In this way, the time-series information may be generated using the reflected waves whose signals (the amplitudes of signals) other than those in the reflected-wave section are substituted with zero. For example, the time-series information may be information based on the reflected sound in which signals other than those in the reflected-wave section are substituted with a predetermined value.

### Other Embodiments

While the information processing method and so on according to one or a plurality of aspects have been described thus far with reference to the embodiment and so on, the present disclosure is not limited to this embodiment and so on. The present disclosure may also include other modes obtained by making various modifications conceivable by those skilled in the art to the embodiment of the present disclosure, or modes constructed by any combinations of constituent elements according to the embodiment and the variations without departing from the scope of the present disclosure.

For example, the information processing device according to the embodiment and so on described above do not necessarily have to include the sound emitter and the sound receiver. The information processing device may be configured to be capable of communication with a device that configures a sound emitter and a sound receiver, and may include a communicator that acquires the reflected sound received by the sound receiver via communication. The communicator is one example of the acquirer and is configured to include, for example, a communication interface. In this case, the information processing device may be located apart from the space where the user is present.

In the embodiment and so on described above, each of the constituent elements may be configured in the form of a dedicated hardware product, or may be realized by executing a software program suitable for the constituent element. Each constituent element may also be realized by a program executor such as a CPU or a processor reading and executing a software program recorded on a recording medium such as a hard disk or semiconductor memory.

The sequence of the steps executed in each flowchart is merely one example in order to specifically describe the present disclosure, and may be any sequence other than that described above. Some of the steps described above may be executed simultaneously (in parallel) with other steps, or some of the steps described above may not be executed.

The way of dividing the functional blocks in each block diagram is merely one example. A plurality of functional blocks may be realized as one functional block, one functional block may be divided into a plurality of functional blocks, or some functions may be transferred to a different functional block. The functions of a plurality of functional blocks having similar functions may be processed in parallel or in time sequence by single hardware or software.

The information processing device according to the embodiment or the like described above may be realized as a single device, or may be realized as a plurality of devices. In the case where the information processing device is realized as a plurality of devices, each of the constituent elements included in the information processing device may be allocated in any way to the plurality of devices. In the case where the information processing device is realized as a plurality of devices, there are no particular limitations on the communication method used between the devices, and the communication method may be performed via either wireless communication or cable communication. Alternatively, wireless communication and cable communication may be used in combination between the devices. The information processing device according to the embodiment or the like described above may also be realized as a cloud server.

The detection device and the information processing device according to the embodiment or the like described above are not limited to separate devices, and may be realized as a single device. In the case where those devices are realized as a single device, the information based on the reflected sound may be a signal including the reflected waves received by the sound receiver, and the sound receiver may function as an acquirer that directly acquires this information (by means of sensing). Alternatively, the detection device may include some of the functions of the information processing device.

Each of the constituent elements described in the embodiment or the like described above may be realized by software, or typically, may be realized by LSI serving as an integrated circuit. These constituent elements may be individually formed into a single chip, or some or all of the constituent elements may be included and formed into a single chip. Although the LSI is described here by way of example, the LSI may be referred to as an IC, a system LSI, a super LSI, or an ultra LSI depending on the degree of integration. The method for circuit integration is not limited to the LSI, and may be realized as a dedicated circuit (a general-purpose circuit for executing a dedicated program) or a general-purpose processor. After the manufacture of the LSI, it is also possible to use a field programmable gate array (FPGA) capable of programming or a reconfigurable processor capable of reconfiguring connections or settings of circuit cells inside the LSI. Moreover, if any other circuit integration technology that replaces the LSI makes its debut with the advance of semiconductor technology or other derivative technology, such technology may of course be used for the integration of the constituent elements.

The system LSI is a super-multi-functional LSI manufactured by integrating a plurality of processing units on a single chip, and is specifically a computer system configured to include, for example, a microprocessor, read only memory (ROM), and random access memory (RAM). The ROM stores computer programs. The system LSI achieves its functions as a result of the microprocessor operating in accordance with the computer programs.

One aspect of the present disclosure may be a computer program that causes a computer to execute each characteristic step included in the information processing method shown in any of FIGS. 3 to 9.

For example, the program may be the one to be executed by a computer. Another aspect of the present disclosure may be a non-transitory computer-readable recording medium having such a program recorded thereon. For example, such a program may be recorded on a recording medium for circulation or distribution. For example, a distributed program may be installed in a device including a different processor, and the processor may be caused to execute the program in order to allow the device to perform each process described above.

### INDUSTRIAL APPLICABILITY

The present disclosure is applicable to an information processing device or the like for recognizing people's actions.

1. An information processing method that is executed by a computer, the information processing method comprising:
acquiring information based on reflected sound obtained by emitting ultrasound into a space;
extracting, from the reflected sound, a reflected wave every cycle of emission of the ultrasound to extract reflected waves;
generating time-series information by concatenating vectors based on the reflected waves each extracted every cycle of emission of the ultrasound;
determining an action of a person in the space in accordance with an output of a trained model, the output being obtained by inputting the time-series information generated to the trained model, the trained model being configured to output, upon receipt of input of time-series information, a human action associated with the time-series information; and
outputting a determination result.

2. The information processing method according to claim 1,
wherein the time-series information includes information obtained by concatenating vectors of the reflected waves as the vectors based on the reflected waves.

3. The information processing method according to claim 2,
wherein the time-series information includes information obtained by arranging amplitudes of the reflected waves each extracted every cycle of emission of the ultrasound.

4. The information processing method according to claim 1, further comprising:
extracting, from the reflected sound, a direct wave every cycle of emission of the ultrasound to extract direct waves; and
calculating impulse responses of the direct waves extracted and the reflected waves extracted,
wherein the time-series information includes information obtained by concatenating, as the vectors based on the reflected waves, vectors of the impulse responses each calculated every cycle of emission of the ultrasound.

5. The information processing method according to claim 4,
wherein the time-series information includes information obtained by arranging amplitudes of the impulse responses each calculated every cycle of emission of the ultrasound.

6. The information processing method according to claim 1, further comprising:
calculating envelopes of the reflected waves extracted,
wherein the time-series information includes information obtained by concatenating vectors of the envelopes as the vectors based on the reflected waves.

7. The information processing method according to claim 1, further comprising:
extracting, from the reflected sound, a direct wave every cycle of emission of the ultrasound to extract direct waves;
calculating impulse responses of the direct waves extracted and the reflected waves extracted; and
calculating envelopes of the impulse responses,
wherein the time-series information includes information obtained by concatenating, as the vectors based on the reflected waves, vectors of envelopes of the impulse responses each calculated every cycle of emission of the ultrasound.

8. The information processing method according to claim 1, further comprising:
calculating acoustic features of the reflected waves each extracted every cycle of emission of the ultrasound,
wherein the time-series information includes information obtained by concatenating vectors of the acoustic features as the vectors based on the reflected waves.

9. The information processing method according to claim 8,
wherein the acoustic features each include a mel-frequency cepstrum coefficient.

10. The information processing method according to claim 8,
wherein the acoustic features each include a linear-frequency cepstrum coefficient.

11. The information processing method according to claim 1, further comprising:
substituting a portion of the reflected sound other than the reflected wave with a predetermined value,
wherein the time-series information includes information based on the reflected sound in which the portion has been substituted with the predetermined value.

12. An information processing device comprising:
an acquirer that acquires information based on reflected sound obtained by emitting ultrasound into a space;
an extractor that extracts, from the reflected sound, a reflected wave every cycle of emission of the ultrasound to extract reflected waves;
a generator that generates time-series information by concatenating vectors based on the reflected waves each extracted every cycle of emission of the ultrasound;
a determiner that determines an action of a person in the space in accordance with an output of a trained model, the output being obtained by inputting the time-series information generated, the trained model being configured to output, upon receipt of input of time-series information, a human action associated with the time-series information; and
an outputter that outputs a determination result.

13. A non-transitory computer-readable recording medium having recorded thereon a program for causing a computer to execute the information processing method according to claim 1.
